(19) United States
(12) Patent Application Publication
(10) Pub. No.: US 2003/0195973 A1
(43) Pub. Date: Oct. 16, 2003

(54) Methods, systems, and computer program products for processing a packet with layered headers using a data structure that positionally relates the layered headers

(76) Inventor: Raymond Savarda, Apex, NC (US)

Correspondence Address: MYERS BIGEL SIBLEY & SAJOVEC, PO BOX 37428, RALEIGH, NC, 27627, US

(21) Appl. No.: 10/120,440

(22) Filed: Apr. 11, 2002

(51) Int. Cl. G06F 15/16

(52) U.S. Cl. 709/230

(57) ABSTRACT

A first header of a packet is processed to obtain a first protocol. The first protocol is used as a key to read a record from a data structure in which the first protocol is associated with an offset in a second header of the packet. The second header of the packet is processed based on the offset in the second header to obtain a second protocol. By positionally relating the position of the protocol field in the second header of the packet with an offset stored in a data structure, if packet sizes and/or layouts should change, then the offset information in the data structure may be updated without the need to redesign and/or reconfigure hardware and/or software in a packet processor.

### BACKGROUND OF THE INVENTION

The present invention relates to packet processing methods, systems, and computer program products, and, more particularly, to methods, systems, and computer program products for processing packets with layered headers.

The Internet Protocol (IP) resides within layer three (network layer) of the Open Systems Interconnection (OSI) model. IP may provide connection or datagram service between nodes in a network. An IP host may encapsulate data with an IP header, which is then passed to the data link layer. The data link protocol may encapsulate the IP header and data with its own header and then pass the encapsulated packet to the physical layer, where the packet may be encapsulated with yet another header, for transmission into the network as a serial bit stream.

The fields used in an IP header for IP Version 4 are shown in FIG. 1. The first field is the version of IP used to create the header. Networks running an older IP version may not be able to process packets encapsulated with headers associated with a newer IP version. An Internet Header Length (IHL) field follows the version field and specifies the length of the IP header in 32-bit words. A type-of-service field follows the IHL field and specifies the quality of service in terms of delay, reliability, and throughput to be applied to the packet. A total length field follows the type-of-service field and specifies the length of the IP header and the data, which follow the IP header. Note that the data may comprise a transport layer header, such as a TCP/UDP header and/or a security header, such as an IP Security Protocol (IPSec) header, along with user payload/data.

An identification (ID) field is used to correlate fragments of a data unit. For example, when a data unit is fragmented, an ID number may be assigned to the various fragments to allow the receiver to match the IDs and reassemble the packet. Three flag bits follow the identification field with one of the bits being hard coded to zero, one of the bits indicating whether fragmentation is allowed, and one of the bits indicating whether the present packet is the last fragment. A fragment offset field follows the flags field and indicates where in the datagram this particular fragment belongs. The first fragment has an offset of zero.

A time-to-live field indicates the amount of time that the packet may remain in the system. The time-to-live field is implemented as a hop counter. Each time the packet traverses through a router, the router decrements this field by one. The packet is destroyed once the time-to-live field reaches zero. This field may prevent undeliverable packets from cycling endlessly through the network. A protocol field follows the time-to-live field and specifies the next level protocol associated with the user payload/data. The Internet Assigned Numbers Authority (IANA) maintains a list of recognized protocols and numbers associated therewith at their Web site www.iana.org. A header checksum follows the protocol field and is a checksum on only the header portion of the IP packet.

Routers and gateways in a network may use the source and destination IP addresses to route the IP packet. An options field may be included and may be used for specific applications, such as network control and/or debugging. A padding field follows the optional options field to ensure that the IP header ends on a 32-bit boundary.

When a packet is traversing nodes or stations in a network, it may become encapsulated with multiple IP headers. Examples of such encapsulation are described in Internet Engineering Task Force (IETF) Request for Comment (RFC) document 2003 entitled “IP Encapsulation within IP,” by C. Perkins, October, 1996 (hereinafter “RFC 2003”), IETF RFC document 2004 entitled “Minimal Encapsulation Within IP,” by C. Perkins, October, 1996 (hereinafter “RFC 2004), IETF RFC document 2406 entitled “IP Encapsulating Security Payload (ESP),” by S. Kent, November 1998 (hereinafter “RFC 2406”), and IETF RFC document 3173 entitled “IP Payload Compression Protocol (IPComp)” by A. Shacham et al., September 2001 (hereinafter “RFC 3173”), the disclosures of which are hereby incorporated herein by reference. In processing IP packets with multiple, layered headers, a conventional packet processor system may parse down from the outer IP header to the inner IP header(s) to examine the protocol field in an inner IP header to determine how to process the IP packet. Conventional packet processor systems may be hard coded in hardware and/or software with offsets used to parse an IP packet with multiple IP headers. Likewise, IP Version 6 follows a similar strategy with nested headers at the beginning of the packet, which constitute different protocol wrappers. Unfortunately, such packet processor systems may need to be re-designed or reconfigured if packet header sizes and/or layouts change

### SUMMARY OF THE INVENTION

According to some embodiments of the present invention, a first header of a packet is processed to obtain a first protocol. The first protocol is used as a key to read a record from a data structure in which the first protocol is associated with an offset in a second header of the packet. The second header of the packet is processed based on the offset in the second header to obtain a second protocol. Advantageously, by positionally relating the position of the protocol field in the second header of the packet with an offset stored in a data structure, if packet sizes and/or layouts should change, then the offset information in the data structure may be updated without the need to redesign and/or reconfigure hardware and/or software in a packet processor.

In other embodiments of the present invention, the record read from the data structure may associate the first protocol with an enable flag. The second header of the packet may be processed based on the offset in the second header to obtain the second protocol if the enable flag is set. The enable flag may allow a “base” set of protocols to be stored in non-volatile storage and copied to volatile storage upon system initialization. Thereafter, certain protocols may be disabled by use of the enable bit.

In still other embodiments of the present invention, the record read from the data structure may associate the first protocol with an offset to a payload/data portion of the packet.

In still other embodiments of the present invention, the packet may be processed based on an operation associated with the second protocol, such as a packet transform operation.

In still further embodiments of the present invention, the record read from the data structure may associate the first protocol with an operation flag and the packet may be processed based on an operation associated with the an operation flag.

In still further embodiments of the present invention, the second protocol may be used as a key to read a second record from the data structure in which the second protocol is associated with an operation flag. The packet may be processed based on an operation associated with the operation flag.

Although described primarily above with respect to method embodiments of the present invention, it will be understood that the present invention may be embodied as methods, systems, and computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a diagram that illustrates a structure of a conventional Internet Protocol (IP) packet header;

FIG. 2 is a diagram that illustrates a packet processing system in accordance with some embodiments of the present invention;

FIG. 3 is a diagram that illustrates a packet with layered headers in accordance with some embodiments of the present invention;

FIG. 4 is a flowchart that illustrates exemplary operations for processing a packet with layered headers in accordance with some embodiments of the present invention;

FIG. 5 is a diagram that illustrates an IP version 4 protocol data structure in accordance with some embodiments of the present invention;

FIG. 6 is a flowchart that illustrates further exemplary operations for processing a packet with layered headers in accordance with some embodiments of the present invention; and

FIG. 7 is a diagram that illustrates an IP version 6 protocol data structure in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

Embodiments of the present invention are described herein in the context of processing a packet. It will be understood that the term “packet” means a unit of information that may be transmitted electronically as a whole from one device to another. Accordingly, as used herein, the term “packet” may encompass such terms of art as “frame” or “message,” which may also be used to refer to a unit of transmission.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

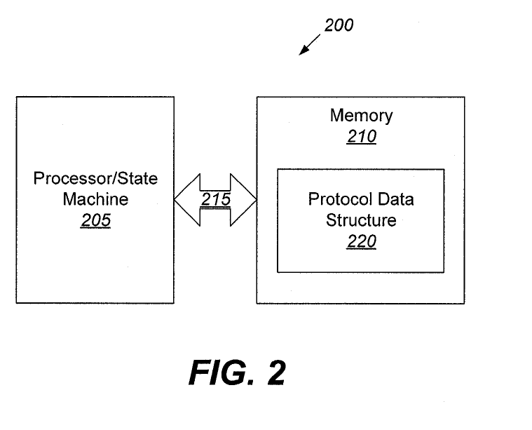

Referring now to FIG. 2, a packet processing system 200 is illustrated that comprises a processor 205 and a memory 210, in accordance with some embodiments of the present invention. The processor 205 communicates with the memory 210 via an address/data bus 215. The processor 205 may be, for example, a commercially available or custom microprocessor. In some embodiments, the processor may be implemented as a packet processing state machine. The memory 210 is representative of one or more memory devices containing the software and data used by the processor 205 to process a packet, in accordance with some embodiments of the present invention. The memory 210 may include, but is not limited to, the following types of devices: cache, ROM, PROM, EPROM, EEPROM, flash, SRAM, and DRAM. To allow the packet processing system 200 to be updated with new software and/or data, particularly in field settings, writeable memory devices may be used. As shown in FIG. 2, the memory 210 comprises a protocol data structure 220 that may facilitate processing of packets with layered headers as will be described in detail hereafter, in accordance with some embodiments of the present invention.

Although FIG. 2 illustrates an exemplary packet processing system architecture that may facilitate processing of packets with layered headers in accordance with some embodiments of the present invention, it will be understood that the present invention is not limited to such a configuration but is intended to encompass any configuration capable of carrying out operations described herein. Moreover, it will be further appreciated that the functionality of the packet processing system 200 may also be implemented using discrete hardware components, one or more application specific integrated circuits (ASICs), or a programmed digital signal processor or microcontroller. As mentioned above with respect to the memory 210, however, a programmable packet processing system 200 may allow the protocol data structure 220 to be updated, even in field settings, when changes are made to packet sizes and/or formats.

In some embodiments of the present invention, the packet processing system 200 may be used to implement one or more packet transform modules that comprise all or part of a plurality of transform modules that are coupled to each other in a series or pipelined configuration to perform packet transforms and/or cryptographic operations associated, for example, with the IPSec protocol as described in U.S. patent application Ser. No. ______, filed concurrently herewith, and entitled Methods, Systems, and Computer Program Products for Processing a Packet-Object Using Multiple Pipelined Processing Modules, the disclosure of which is hereby incorporated herein by reference.

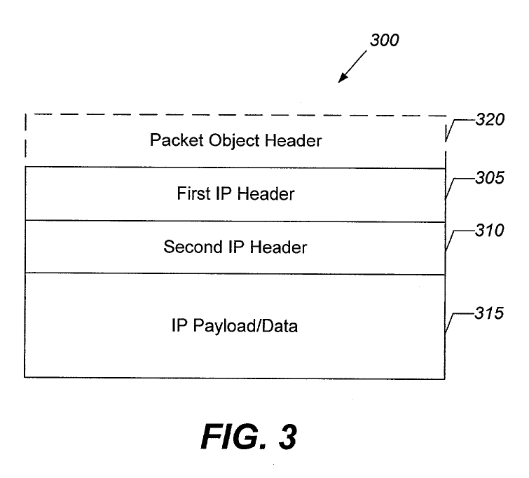

Referring now to FIG. 3, a packet 300 comprising multiple layered headers, in accordance with some embodiments of the present invention, is illustrated. The packet 300 may be an IP packet, for example, and comprises a first (outer) IP header 305 that encapsulates a second (inner) IP header 310 and an IP payload/data portion 315. Optionally, a packet-object header 320 may be used, which encapsulates the entire packet 300. The packet-object header 320 may comprise information for processing the packet 300 in a pipelined processing system as described in U.S. patent application Ser. No. ______, entitled Methods, Systems, and Computer Program Products for Processing a Packet-Object Using Multiple Pipelined Processing Modules. Although only two layered IP headers 305 and 310 are shown, the packet 300 may comprise additional IP headers as described in RFC 2003, RFC 2004, RFC 2406, and/or RFC 3173. The IP payload/data 315 may comprise a user payload/data, such as a UDP or TCP payload, and, in some embodiments, may include cryptographic header(s)/information for IPSec processing, such as, but not limited to, an authentication header (AH), an encapsulating security payload (ESP), AH authentication data, and/or ESP authentication data.

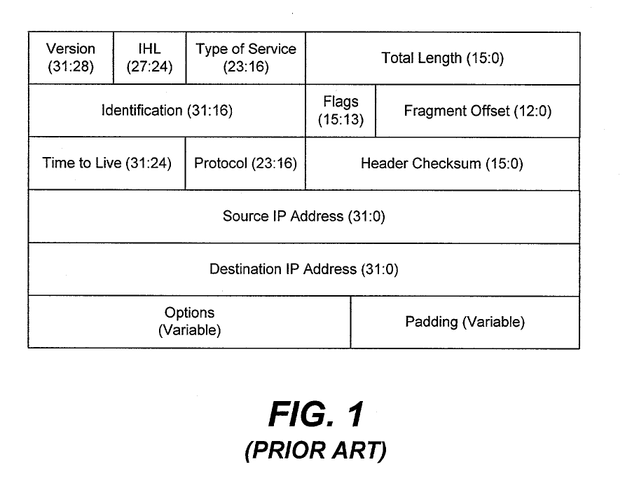

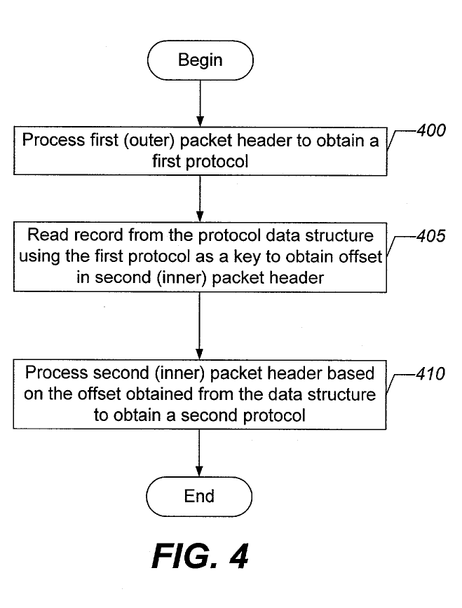

Referring now to FIG. 4, exemplary operations for processing a packet with layered headers, in accordance with some embodiments of the present invention, begin at block 400 where a first packet header (e.g., first IP header 305 of FIG. 3) is processed to obtain a first protocol (e.g., protocol field of FIG. 1). Some networks may process packets differently based on the protocol associated with the packet. For example, a network may reject packets associated with Web traffic, but may accept packets associated with e-mail traffic. Thus, it may be desirable to parse a packet with layered headers to evaluate the underlying protocol(s) associated with the packet.

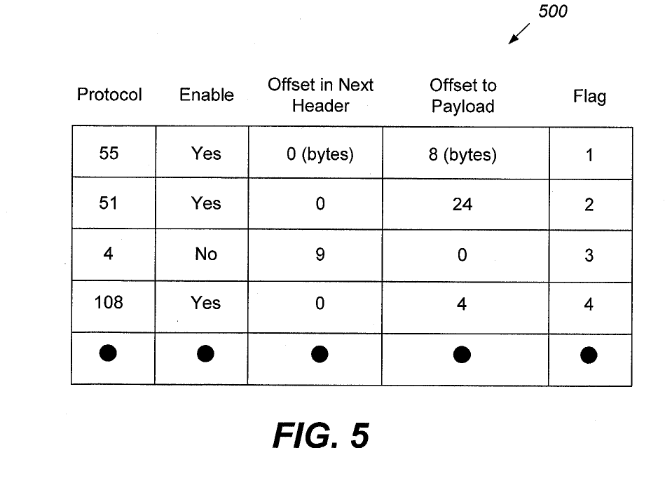

In accordance with some embodiments of the present invention, the first protocol is used as a key to read a record from the protocol data structure 220 at block 405 to obtain an offset to a second packet header (e.g., second IP header 310 of FIG. 3). This is illustrated, for example, in FIG. 5 where an exemplary data structure 500 is shown that may be used as the protocol data structure 220, in accordance with some embodiments of the present invention. As shown in FIG. 5, the data structure 500 comprises a table of records with each record comprising a protocol field, an enable field, and offset in next header field, an offset to payload field, and a flag field. The protocol field corresponds to the protocol field in a packet header. The enable field may be implemented as a binary, “yes” or “no” field that indicates whether to parse a packet for encapsulated headers/protocols. The offset in next header field indicates a location of a protocol field in an encapsulated header. The offset to payload field indicates a location of a payload/data portion of the packet (e.g., IP payload/data 315 of FIG. 3). The flag field may indicate operations to be performed on the packet for a particular protocol. For example, such operations may include packet-processing operations for extracting the source and/or destination port addresses. The protocol data structure 220 is not limited to these fields and may comprise additional fields or may exclude one or more of the fields illustrated in FIG. 5, in accordance with various embodiments of the present invention. Moreover, although a table is shown in FIG. 5, other data structure types may be used without departing from the principles of the present invention.

Returning to the description of FIG. 4, a record from the protocol data structure is read at block 405 using the first protocol as a key to obtain an offset in a second (inner) packet header. Based on the example shown in FIG. 5, the offset to the protocol field in the second packet header for protocol 4 as the first (outer) packet header protocol is nine bytes. Thus, at block 410, the second packet header may be processed based on the offset in the next header obtained from the protocol data structure 220 to obtain a second protocol. The packet may then be processed based on one or more operations associated with the first and/or second protocol, such as packet transform operations and/or extraction of source and/or destination port addresses.

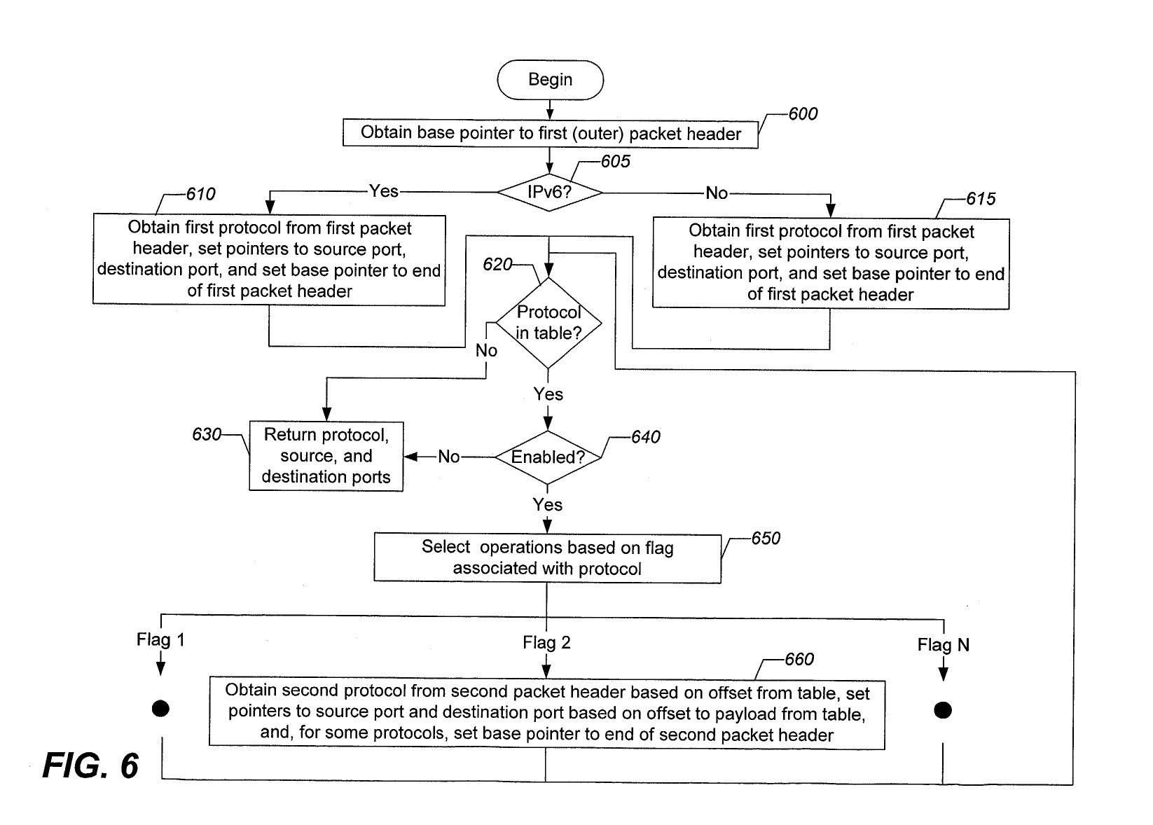

Referring now to FIG. 6, exemplary operations for processing a packet with layered headers, in accordance with some embodiments of the present invention, will now be described. Operations begin at block 600 where a base pointer is obtained to a first (outer) packet header (e.g., first IP header 305 of FIG. 3). In some embodiments, it may be desirable to process packets differently based on a particular protocol version, such as different IP version. Thus, at block 605, a determination may be made whether the packet is an IP version 6 packet. If the packet is an IP version 6 packet, then operations continue at block 610 where the packet is processed to obtain a first protocol from the first packet header. In the context of IPSec, a set of “selectors” may be extracted from a packet for processing. These selectors may include the “transport” protocol and the TCP/UDP source and/or destination port addresses. Accordingly, at block 610, pointers may be set to the source and destination port addresses in the first packet header. Finally, based on the size of the first packet header (e.g., the IHL field of FIG. 1), the base pointer may be set to point to the end of the first packet header (i.e., the beginning of information following the first packet header). If the packet is not an IP version 6 packet, then the operations of block 610 are performed at block 615 for the non-IPv6 packet.

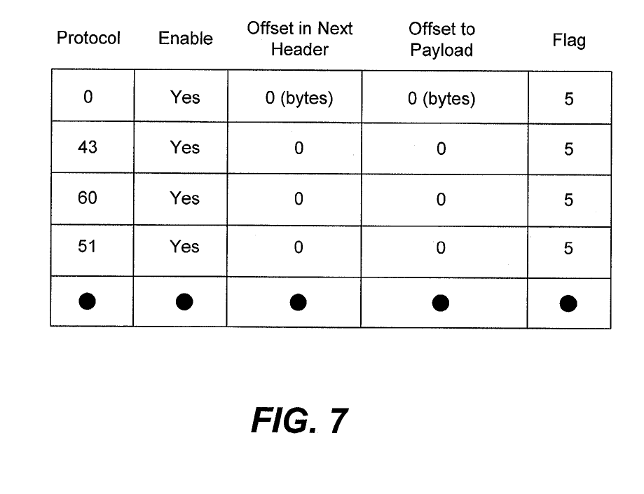

At block 620, a determination is made whether the first protocol is in the protocol data structure 220 (e.g., the table of FIG. 5). In various embodiments of the present invention, separate protocol data structures 220 may be defined for different packet protocol versions or formats. For example, different protocol data structures 220 may be defined for IP version 6 environments and IP version 4 environments. FIG. 5 illustrates an exemplary protocol data structure 220 for an IP version 4 environment while FIG. 7 illustrates an exemplary protocol data structure 220 for an IP version 6 environment. If the first protocol is not in the protocol data structure 220, then the protocol, source port address, and/or destination port address may be returned at block 630. If the first protocol is in the protocol data structure 220, however, then operations continue at block 640 where a determination is made whether an enable flag is set in the protocol data structure 220 for the first protocol. Advantageously, the enable flag may allow a “base” set of protocols to be stored in non-volatile storage and copied to volatile storage upon system initialization. Thereafter, certain protocols may be disabled by use of the enable bit. If the enable flag is not set, then an encapsulated header is not processed and operations conclude at block 630 as discussed above.

If, however, the enable flag is set (e.g., the enable flag is set for protocols 55, 51, and 108 in FIG. 5), then the flag field from the protocol data structure 220 is examined at block 650 to determine which set of packet processing operations to perform. As shown in FIG. 5, each protocol is associated with a different flag value. In some embodiments, however, protocols may share a common flag value as encapsulated headers for those protocols may be processed similarly. At block 660, a second (inner) packet header may be processed to obtain a second protocol based on the offset in the next header from the protocol data structure 220. Using a first protocol value of 51 as an example, FIG. 5 shows the offset to the protocol field in the second packet header as being zero bytes. In addition, the protocol data structure 220 may also be used to process the payload/data field and/or other fields in the second packet header. Again, using a first protocol value of 51 as an example, FIG. 5 shows the offset to the payload as being 24 bytes. In some embodiments, the offset to payload field in the protocol data structure 220 may contain an offset that facilitates the extraction of the source and/or destination port addresses. Thus, at block 660, pointers may be set to the source and/or destination port addresses. Finally, in some embodiments, the base pointer may be set to the end of the second packet header (i.e., the beginning of information following the second packet header) if it is possible to have one or more additional encapsulated headers.

Operations continue at block 620 where a determination is made whether there is an additional encapsulated protocol that is in the protocol data structure. The loop may repeat until all encapsulated headers that are in the protocol data structure 220 are processed. It will be understood that the protocols illustrated in FIG. 5, IP mobility (55), authentication header (51), IP in IP (4), and IP payload compression protocol (108), and the protocols illustrated in FIG. 6, IPv6 hop by hop option (0), routing header for IPv6 (43), destination options for IPv6 (60), and authentication header (51) are merely exemplary and that other protocols may be used in accordance with various embodiments of the present invention.

The flowcharts of FIGS. 4 and 6 illustrate the architecture, functionality, and operations of some embodiments of the packet processing system 200. In this regard, each block represents a module, segment, or portion of code, which comprises one or more executable instructions for implementing the specified logical function(s). It should also be noted that in other implementations, the function(s) noted in the blocks may occur out of the order noted in FIGS. 4 and 6. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

We claim:

1. A method of processing a packet, comprising:
processing a first header of the packet to obtain a first protocol;
reading a record from a data structure using the first protocol as a key, the record associating the first protocol with an offset in a second header of the packet; and
processing a second header of the packet based on the offset in the second header to obtain a second protocol.

2. The method of claim 1, wherein the record associates the first protocol with an enable flag, and wherein processing the second header of the packet comprises:
processing the second header of the packet based on the offset in the second header to obtain the second protocol if the enable flag is set.

3. The method of claim 2, wherein the record associates the first protocol with an offset to a payload of the packet, the method further comprising:
processing the payload of the packet based on the offset to the payload if the enable flag is set.

4. The method of claim 1, further comprising:
processing the packet based on an operation associated with the second protocol.

5. The method of claim 4, wherein the operation associated with the second protocol comprises a packet transform operation.

6. The method of claim 1, wherein the record associates the first protocol with an operation flag, the method further comprising:
processing the packet based on an operation associated with the operation flag.

7. The method of claim 1, wherein the record is a first record, the method further comprising:
reading a second record from the data structure using the second protocol as a key, the second record associating the second protocol with an operation flag; and
processing the packet based on an operation associated with the operation flag.

8. The method of claim 1, wherein the packet is a cryptographic packet.

9. The method of claim 1, wherein the packet comprises a packet-object header containing information for processing the packet in a pipelined processing system.

10. A method of relating packet headers in a data structure, comprising:
associating a protocol from a first header of a packet with an offset in a second header of a packet.

11. The method of claim 10, further comprising:
associating the protocol from the first header of the packet with an offset to a payload of the packet.

12. The method of claim 11, wherein the second header of the packet is an inner header and the first header of the packet is an outer header that encapsulates the inner header.

13. The method of claim 10, further comprising:
associating the protocol with an operation flag that specifies an operation to be performed on the packet.

14. The method of claim 10, wherein the protocol is a first protocol, the method further comprising:
associating a second protocol from the second header of the packet with an operation flag that specifies an operation to be performed on the packet.

15. The method of claim 10, wherein the protocol is a first protocol, the method further comprising:
associating the first protocol with an enable flag that specifies whether to determine a second protocol from the second header of the packet.

16. A system for processing a packet, comprising:
means for processing a first header of the packet to obtain a first protocol;
means for reading a record from a data structure using the first protocol as a key, the record associating the first protocol with an offset in a second header of the packet; and
means for processing a second header of the packet based on the offset in the second header to obtain a second protocol.

17. The system of claim 16, wherein the record associates the first protocol with an enable flag, and wherein the means for processing the second header of the packet comprises:
means for processing the second header of the packet based on the offset in the second header to obtain the second protocol if the enable flag is set.

18. The system of claim 17, wherein the record associates the first protocol with an offset to a payload of the packet, the system further comprising:
means for processing the payload of the packet based on the offset to the payload if the enable flag is set.

19. The system of claim 16, further comprising:
means for processing the packet based on an operation associated with the second protocol.

20. The system of claim 19, wherein the operation associated with the second protocol comprises a packet transform operation.

21. The system of claim 16, wherein the record associates the first protocol with an operation flag, the system further comprising:
means for processing the packet based on an operation associated with the operation flag.

22. The system of claim 16, wherein the record is a first record, the system further comprising:
means for reading a second record from the data structure using the second protocol as a key, the second record associating the second protocol with an operation flag; and
means for processing the packet based on an operation associated with the operation flag.

23. The system of claim 16, wherein the packet is a cryptographic packet.

24. The system of claim 16, wherein the packet comprises a packet-object header containing information for processing the packet in a pipelined processing system.

25. A computer program product for processing a packet, comprising:
a computer readable program medium having computer readable program code embodied therein, the computer readable program code comprising:
computer readable program code configured to process a first header of the packet to obtain a first protocol;
computer readable program code configured to read a record from a data structure using the first protocol as a key, the record associating the first protocol with an offset in a second header of the packet; and
computer readable program code configured to process a second header of the packet based on the offset in the second header to obtain a second protocol.

26. The computer program product of claim 25, wherein the record associates the first protocol with an enable flag, and wherein the computer readable program code configured to process the second header of the packet comprises:
computer readable program code configured to process the second header of the packet based on the offset in the second header to obtain the second protocol if the enable flag is set.

27. The computer program product of claim 26, wherein the record associates the first protocol with an offset to a payload of the packet, the computer program product further comprising:
computer readable program code configured to process the payload of the packet based on the offset to the payload if the enable flag is set.

28. The computer program product of claim 25, further comprising:
computer readable program code configured to process the packet based on an operation associated with the second protocol.

29. The computer program product of claim 28, wherein the operation associated with the second protocol comprises a packet transform operation.

30. The computer program product of claim 25, wherein the record associates the first protocol with an operation flag, the computer program product further comprising:
computer readable program code configured to process the packet based on an operation associated with the operation flag.

31. The computer program product of claim 25, wherein the record is a first record, the computer program product further comprising:
computer readable program code configured to read a second record from the data structure using the second protocol as a key, the second record associating the second protocol with an operation flag; and
computer readable program code configured to process the packet based on an operation associated with the operation flag.

32. The computer program product of claim 25, wherein the packet is a cryptographic packet.

33. The computer program product of claim 25, wherein the packet comprises a packet-object header containing information for processing the packet in a pipelined processing system.

34. A computer program product, comprising:
a computer readable program medium having a computer readable data structure embodied therein, the computer readable data structure comprising:
a table that associates a protocol from a first header of a packet with an offset in a second header of a packet.

35. The computer program product of claim 34, wherein the table further associates the protocol from the first header of the packet with an offset to a payload of the packet.

36. The computer program product of claim 35, wherein the second header of the packet is an inner header and the first header of the packet is an outer header that encapsulates the inner header.

37. The computer program product of claim 34, wherein the table further associates the protocol with an operation flag that specifies an operation to be performed on the packet.

38. The computer program product of claim 34, wherein the protocol is a first protocol, and the table further associates a second protocol from the second header of the packet with an operation flag that specifies an operation to be performed on the packet.

39. The computer program product of claim 34, wherein the protocol is a first protocol, and the table further associates the first protocol with an enable flag that specifies whether to determine a second protocol from the second header of the packet.

40. A method of processing an Internet Protocol Security (IPSec) packet, comprising:
processing a first header of the packet to obtain a first IPSec protocol;
reading a record from a data structure using the first protocol as a key, the record associating the first IPSec protocol with an offset in a second header of the packet and an offset to a payload of the packet;
processing a second header of the packet based on the offset in the second header to obtain a second IPSec protocol; and
processing the packet based on the offset to the payload of the packet to obtain at least one of a source and a destination port address.

41. The method of claim 40, wherein the IPSec packet is an IP version 4 packet, and the first IPSec protocol is one of IP mobility, authentication header, IP in IP, and IP payload compression protocol.

42. The method of claim 40, wherein the IPSec packet is an IP version 6 packet, and the first IPSec protocol is one of IPv6 hop by hop option, routing header for IPv6, destination options for IPv6, and authentication header.

43. A Internet Protocol Security (IPSec) packet processing system, comprising:
means for processing a first header of the packet to obtain a first IPSec protocol;
means for reading a record from a data structure using the first protocol as a key, the record associating the first IPSec protocol with an offset in a second header of the packet and an offset to a payload of the packet;
means for processing a second header of the packet based on the offset in the second header to obtain a second IPSec protocol; and
means for processing the packet based on the offset to the payload of the packet to obtain at least one of a source and a destination port address.

44. The system of claim 43, wherein the IPSec packet is an IP version 4 packet, and the first IPSec protocol is one of IP mobility, authentication header, IP in IP, and IP payload compression protocol.

45. The system of claim 43, wherein the IPSec packet is an IP version 6 packet, and the first IPSec protocol is one of IPv6 hop by hop option, routing header for IPv6, destination options for IPv6, and authentication header.

46. A computer program product, comprising:
a computer readable program medium having computer readable program code embodied therein, the computer readable program code comprising:
computer readable program code configured to process a first header of the packet to obtain a first IPSec protocol;
computer readable program code configured to read a record from a data structure using the first protocol as a key, the record associating the first IPSec protocol with an offset in a second header of the packet and an offset to a payload of the packet;
computer readable program code configured to process a second header of the packet based on the offset in the second header to obtain a second IPSec protocol; and
computer readable program code configured to process the packet based on the offset to the payload of the packet to obtain at least one of a source and a destination port address.

47. The computer program product of claim 47, wherein the IPSec packet is an IP version 4 packet, and the first IPSec protocol is one of IP mobility, authentication header, IP in IP, and IP payload compression protocol.

48. The computer program product of claim 47, wherein the IPSec packet is an IP version 6 packet, and the first IPSec protocol is one of IPv6 hop by hop option, routing header for IPv6, destination options for IPv6, and authentication header.
